(19) United States
(12) Patent Application Publication
(10) Pub. No.: US 2020/0320002 A1
(43) Pub. Date: Oct. 8, 2020

(54) INTELLIGENTLY MANAGING DATA FACILITY CACHES

(71) Applicant: EMC IP Holding Company LLC, Hopkinton, MA (US)

(72) Inventors: Ramesh Doddaiah, Hopkinton, MA (US); Rong Yu, West Roxbury, MA (US)

(21) Appl. No.: 16/375,545

(22) Filed: Apr. 4, 2019

(51) Int. Cl. G06F 12/0804

(52) U.S. Cl. CPC G06F 12/0804; G06F 2212/602; G06F 2212/608

(57) ABSTRACT

Architectures and techniques are described that can address challenges associated with efficiently managing a cache of a data facility. In that regard, for each block (or other file system structure) of a storage array spanning multiple storage device, relationships can be established between other blocks of the array. The blocks can then be represented as multidimensional vectors, and an aggregation of the vectors can be represented as a weight matrix having values that reflect the corresponding relationships between any two given blocks. In response to any given IO transaction, a corresponding vector can be selected that is representative of a block referenced by the IO transaction and one or more target blocks having a high relationship value to the block can be identified and used in connection with a cache update procedure.

### TECHNICAL FIELD

The present application relates generally to techniques for intelligently managing a cache, such as a read cache or a write cache, of a data facility and more particularly to efficiently using the cache to store data that is determined to be more likely to be referenced by a future IO transaction.

### BACKGROUND

An important metric for remote data facilities that provide remote storage services or the like, is response time, which can represent the time between an IO request and serving that IO request. Typically, an IO request from a client or host is received by a frontend device of the data facility. In the case of a read request, the frontend device might communicate with storage devices at the backend to retrieve the requested data, then forward that data to the host.

To reduce response times, it is common that a data facility implements one or more caches at the frontend device. These caches can temporarily store, at the frontend, a small portion of the backend data. If a host requests data that is already in the cache, referred to as a cache ‘hit’ that data can be served more rapidly and thus reduce the response time. Otherwise, a cache ‘miss’ results, and the data must be retrieved from the backend. A response time for a cache miss can be higher than a response time for a cache hit by an order of magnitude or more. Therefore, increasing the likelihood of a cache hit can significantly improve average response times of a data facility.

### BRIEF DESCRIPTION OF THE DRAWINGS

Numerous aspects, embodiments, objects, and advantages of the present invention will be apparent upon consideration of the following detailed description, taken in conjunction with the accompanying drawings, in which like reference characters refer to like parts throughout, and in which:

FIG. 1 illustrates a block diagram of an example data facility in accordance with certain embodiments of this disclosure;

FIG. 2 illustrates a block diagram of an example system that can intelligently manage a cache of a data facility to significantly improve cache hit rates in accordance with certain embodiments of this disclosure;

FIG. 3 depicts a diagram of an example multidimensional vector representation (shown at left) of a logical block and weight relationships to other blocks of a storage array (shown at right) in accordance with certain embodiments of this disclosure;

FIG. 4A is an illustration that depicts an example in which a single input vector is projected to identify target tracks in accordance with certain embodiments of this disclosure;

FIG. 4B is an illustration that depicts an example in which a multiple input vectors are projected to identify one target track in accordance with certain embodiments of this disclosure;

FIG. 5 illustrates a block diagram of an example system illustrating additional aspects or elements in connection with procedures to update cache 110 in accordance with certain embodiments of this disclosure;

FIG. 6 depicts an example block diagram that illustrates additional aspects or elements in connection with neural network training in accordance with certain embodiments of this disclosure;

FIG. 7 illustrates an example methodology that can intelligently manage a cache of a data facility to significantly improve cache efficiency in accordance with certain embodiments of this disclosure;

FIG. 8 illustrates an example methodology that can provide for additional aspect or elements in connection with intelligently managing a cache of a data facility in accordance with certain embodiments of this disclosure;

FIG. 9 illustrates a block diagram of an example distributed file storage system that employs tiered cloud storage in accordance with certain embodiments of this disclosure; and

FIG. 10 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

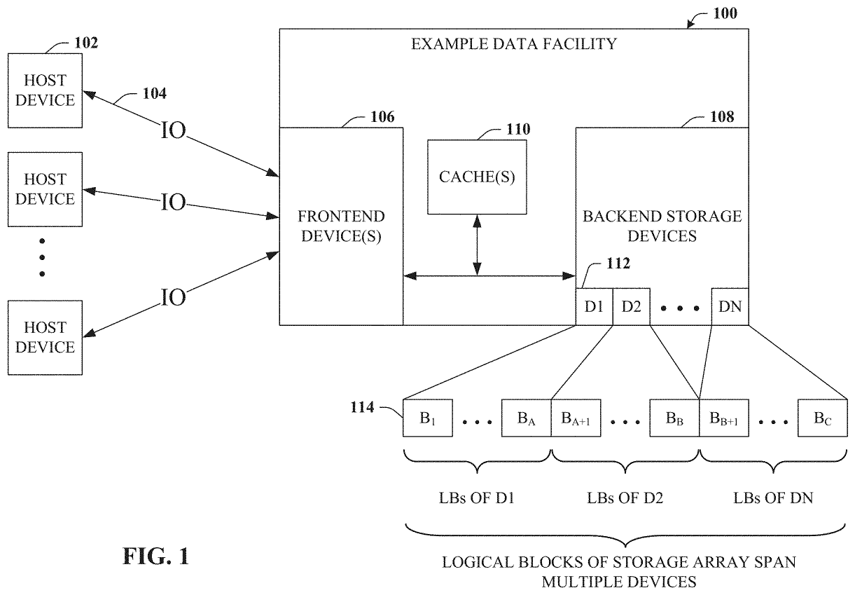

FIG. 1 illustrates an example data facility 100 in accordance with certain embodiments of this disclosure. Data facility 100 can, for example, provide services (e.g., storage services) to one or more host devices, one of which is labeled as host device 102. Host device 102 can communicate with data facility 100, for instance, by initiating an IO transaction 104. IO transaction 104 can be a read transaction that requests data stored by data facility 100 or a write transaction that supplies data to be stored to data facility 100.

Data facility 100 can comprise one or more frontend devices 106 that can interface with host device(s) 102 and receive and service IO transaction(s) 104. Data facility 100 can further comprise backend storage devices 108, which can house data for clients. In a typical example, frontend device 106 can satisfy a read request (e.g., IO transaction 104) by retrieving the requested data from backend storage devices 108 and forwarding that data to host device 102. However, the same read request can be satisfied much more rapidly if the requested data resides in cache 110 because, in that case, the response time can exclude the time required to retrieve the data from the backend storage devices 108.

However, because the storage capacity of cache 110 is relatively small relative to backend storage devices 108, only a tiny fraction of all client data can be prefetched to cache 110 at a given time. Correctly anticipating which data will be requested by host devices 102 can significantly improve response times. Conventional approaches typically manage caches according to a last-used policy, which relies on the assumption that more recently requested data is more likely to be requested in the near-term future than less recently requested data. These and other approaches may increase cache efficiency, but cache efficiency (e.g., cache hit rates) remain low in conventional systems, and can be improved.

The disclosed subject matter, in some embodiments, is holistically directed to determining relationships between logical blocks of client data. If a relationship exists between two logical blocks of client data, then that relationship can be leveraged to establish a relationship between IO transactions 104. In other words, if there is a strong relationship between two logical blocks, then an IO transaction 104 that references the first of those logical blocks can be indicative of a forthcoming IO transaction 104 that references the second logical block. One can readily appreciate therefore that data of the second logical block represents a likely candidate for prefetching to cache 110. In some embodiments, the relationships determined can be leveraged to intelligently manage cache 110, for both read transactions (e.g., a read cache) applications and write transactions (e.g., a write cache) applications. Such a result is especially challenging in cases where the logical blocks of client data span multiple devices.

FIG. 1 provides addition context in that regard, illustrating backend storage devices 108 comprising a group of storage devices (D1, D2, . . . DN), one of which is labeled storage device 112. As illustrated, storage device 112 stores client data in a series of logical blocks (e.g., from logical block B₁ to logical block B_{A}), one of which is denoted as logical block 114. Another of the storage devices 112 (D2 in this case) stores client data from logical block B_{A+1} to logical block B_{B}, which continues from the previous series of logical blocks, and so on. One result is that the logical blocks of a storage array provided by backend storage devices 108 can span multiple devices. In such a scenario, efficiently managing caches can be particularly challenging. Previous approaches are insufficient or incomplete and do not satisfactorily improve cache hit rates.

As will be explained in more detail, the disclosed subject matter can, in some embodiments, generate vector representations of the logical blocks in the storage array. For example, a multidimensional vector can be constructed for all (or a portion of) logical blocks in the storage array. A given vector can include a respective relationship weight between the corresponding block and other blocks of the storage array. Once the weight relationships are discovered (e.g., via training or other machine learning techniques), these vectors can be aggregated into a weight matrix. This weight matrix can be applied to data relating to incoming IO transactions to indicate target blocks that have a relationship to the block referenced by the incoming IO transactions. For example, the incoming IO transactions will reference certain blocks. The weight matrix can be used to identify other blocks that have a relationship, which can then be used manage the cache in an appropriate will to increase efficiency for read caches or write caches.

As used herein a logical block can be referred to as simply a ‘block’ and can be of any suitable size. By way of example, many data facilities store client data in logical blocks that have a fixed size of 512 bytes. Hence, as used herein, a logical block can store 512 bytes or some other value. While a logical block is used as a representative example in this disclosure, other data sizes are contemplated. For example, in some embodiments, the disclosed subject matter can be employed with what is referred to herein as a ‘track’. A track can represent some multiple of a block. For example, a track can be 256 blocks, or some other number.

In other words, in a first embodiments, a vector can be mapped to a logical block of data (e.g., 512 bytes), whereas in a second embodiment, the vector can be mapped to a track of data (e.g., 256 blocks). Such can allow a degree of tailoring to a particular application or implementation. It is appreciated that some trade-offs between these implementations might exist. For example, the first embodiment can potentially provide more efficient utilization of the cache, whereas the second embodiments can potentially result in smaller weight matrices and/or fewer computations.

### Example Systems

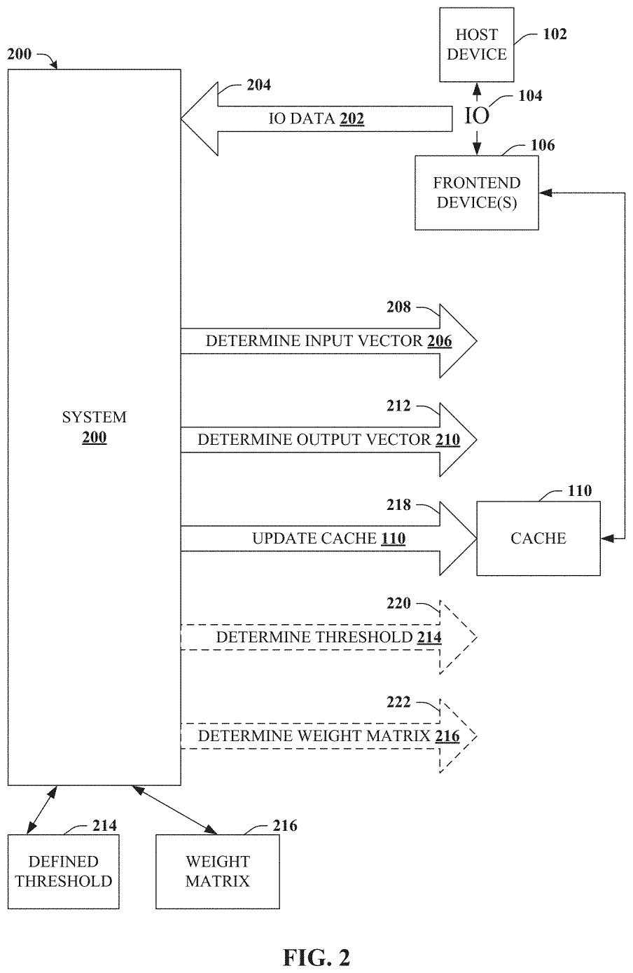

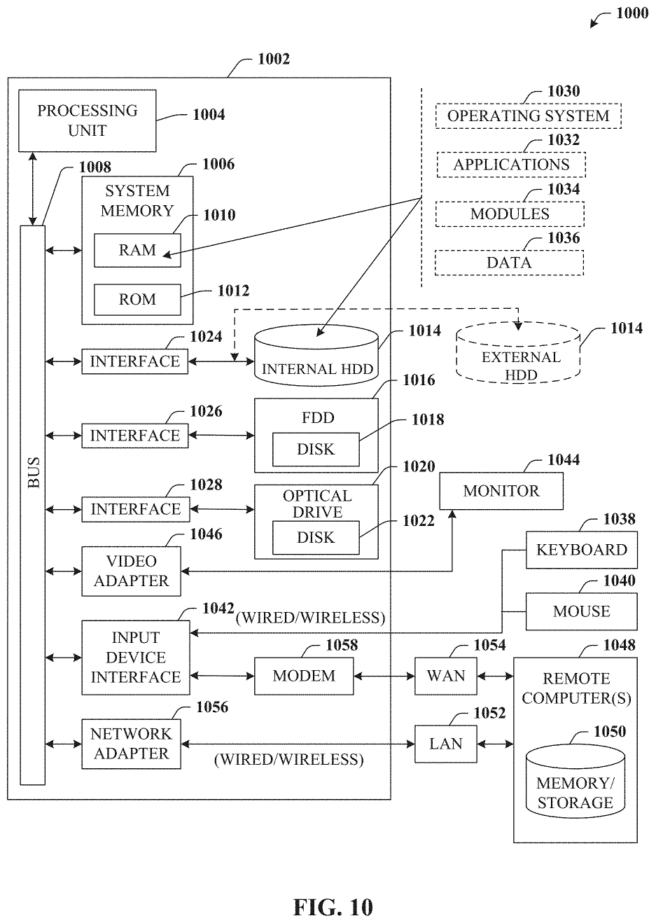

Referring now to FIG. 2, a block diagram of an example system 200 is depicted. System 200 can intelligently manage a cache of a data facility to significantly improve cache hit rates in accordance with certain embodiments of this disclosure. Generally, system 200 (and other system or devices detailed herein) can comprise a processor and a memory that stores executable instructions that, when executed by the processor, facilitate performance of operations. Examples of the memory and processor can be found with reference to FIG. 10. It is to be appreciated that the computer 1002 can represent a server device or a client device and can be used in connection with implementing one or more of the systems, devices, or components shown and described in connection with FIG. 2 and other figures disclosed herein.

In some embodiments, system 200 can be included in or communicatively coupled to data facility 100. For example, system 200 can be included in or coupled to frontend device 106 or cache 110. As such, FIG. 1 can be a useful reference during the description of FIG. 2 and other figures herein. System 200 can receive IO data 202. IO data 202 can be indicative of IO transaction 104 received by frontend device 106 of data facility 100. As detailed IO transaction 104 typically references a logical block from among an array of logical blocks that span multiple storage devices of data facility 100. In addition to the reference to a logical block, IO data 202 might also include other information relating to IO transaction 104 such as a time stamp, a type of IO transaction (e.g., read or write), a source (e.g., host 102 ID), number of blocks being referenced, and so forth.

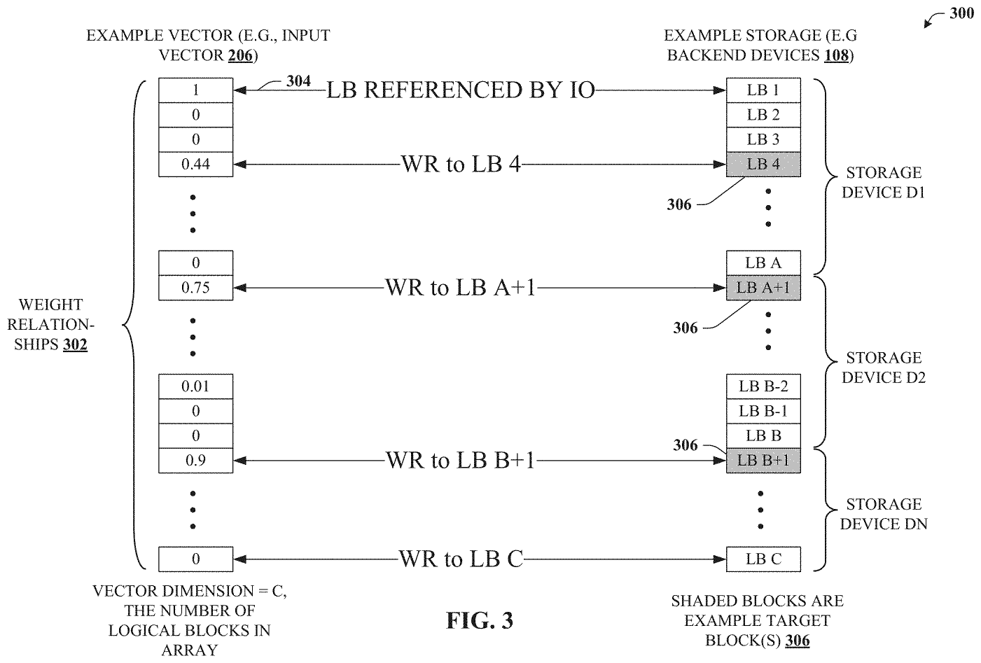

In response to IO data 202, system 200 can determine input vector 206, which is depicted by determination 208. Input vector 206 can represent the logical block referenced by IO transaction 104. As noted, input vector 206 can be a multidimensional vector. For instance, a dimension of input vector 206 can be equivalent to a count of logical blocks in array provided by backend devices 108, which is discussed in more detail with reference to FIG. 3.

As depicted by determination 212, system 200 can further determine output vector 210. Output vector 210 can represent a target block of the array. The target block can be selected based on a determined weight relationship between the target block and the logical block being above defined threshold 214. In other words, if a given block has a weight relationship with the block indicated by IO data 202 that is above defined threshold 214, such can indicate that there is a strong relationship between the two blocks. Therefore, because the first block was referenced by IO transaction 104 (as ascertained from IO data 202), there can be a significantly better than random chance that blocks having the strong relationship (e.g., target blocks) will be referenced by a subsequent IO transaction. It is appreciated that vectors can be used herein as a proxy for logical blocks (or in other embodiments, tracks), and thus establishing a relationship between two vectors can be equivalent to establishing a relationship between the corresponding two logical blocks.

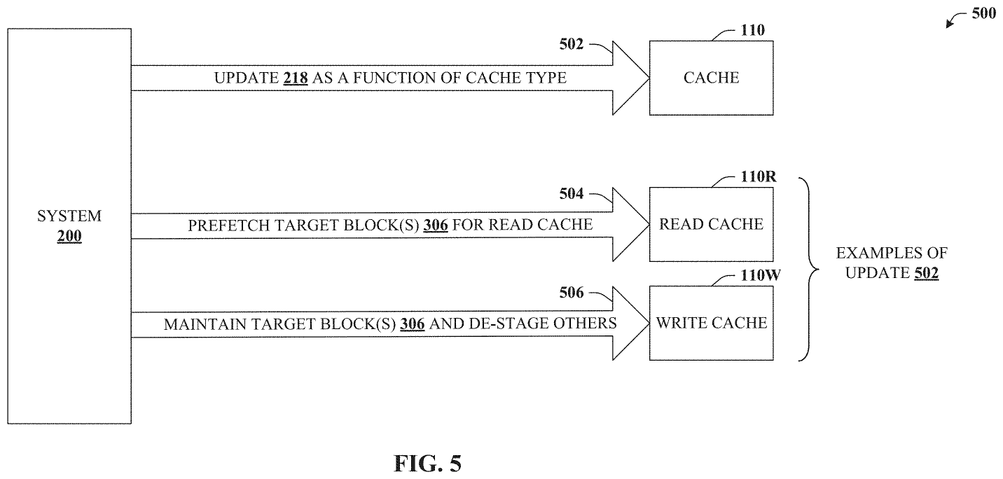

Thus, updating cache 110 based on the determined weight relationship can result in improved cache efficiency and faster response times, which is illustrated by update 218. It is appreciated that update 218 can differ based on the type of IO transaction 104 that is being examined, so update 218 can take a different form for a read cache than for a write cache. In other words, in some embodiments, update 218 can be a function of a type of cache 110, which is further detailed in connection with FIG. 5.

System 200 can further optionally or in some embodiments determine threshold 214, which is illustrated by determination 220. It is appreciated that the value of threshold 214 can directly impact the number of target blocks that are identified. For instance, if threshold 214 is a high value, fewer blocks in the array will qualify as target blocks. Conversely, if threshold 214 is a low value, more blocks in the array will qualify. Thus, threshold 214 can represent a configurable parameter that can be set or determined based on goals or constraints of a given implementation.

In some embodiments, threshold 214 can be a relative, conditional, or dynamic value instead of a fixed value. For instance, in some embodiments, threshold 214 might operate, e.g., to select the highest weight relationship, the top 1000 highest weight relationships, or the like, which can be effectuated by determination 220. In some embodiments, determination 220 can determine threshold 214 as a function of available space of cache 110. For example, if cache 110 has very little available space, threshold 214 might be set to a relatively high value, whereas if cache 110 has much available space, threshold 214 might be set to a relatively low value.

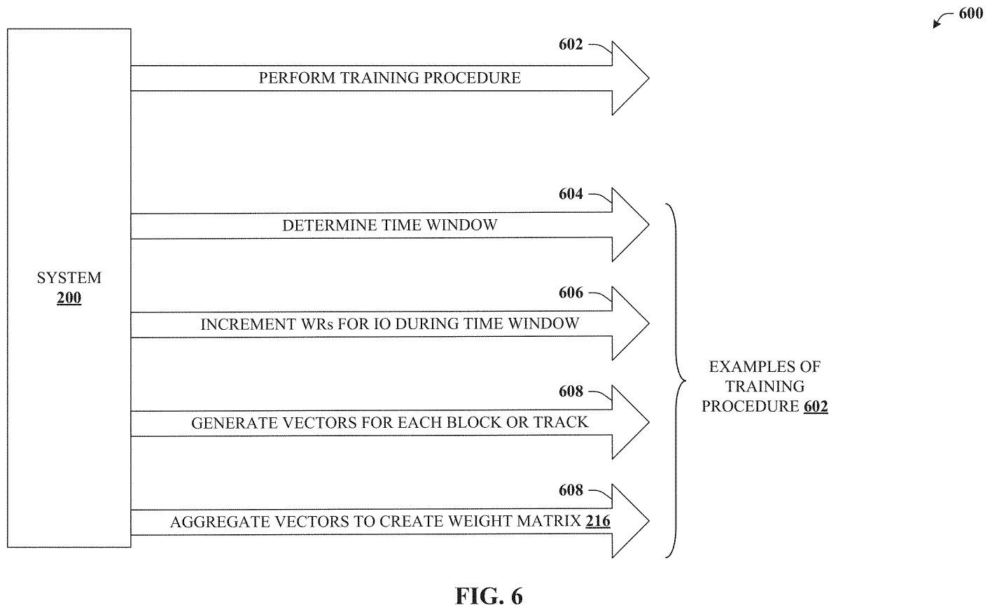

In some embodiments, determination 212 can comprise applying input vector 206 to weight matrix 216. Weight matrix 216 can comprise a number of vectors equivalent to the count of the blocks in the array, wherein a vector of the vectors can represent a block of the array and can indicate respective weight relationships between the block and other blocks of the array. Weight matrix 216 is further detailed in connection with FIG. 6, but it is appreciated that determination 222 in which weight matrix 216 can be generated can occur in advance, e.g., during a training or learning procedure.

While still referring to FIG. 2, but turning now as well to FIG. 3, block diagram 300 is illustrated. Diagram 300 depicts an example multidimensional vector representation (shown at left) of a logical block and weight relationships 302 to other blocks of a storage array (shown at right) in accordance with certain embodiments of this disclosure. As illustrated, the number of dimensions of the vector can match the number of logical blocks in the storage array. The example data facility illustrated at FIG. 1 indicated that the total number of logical blocks 114 of storage devices 112 is C. Thus, continuing from that example, a vector mapped to any one of those C logical blocks can have C dimensions, that is, a dimension entry for every other logical block.

In this example, it is assumed that IO transaction 104 referenced the very first logical block in the array (e.g., B₁ of FIG. 1 or LB 1 here), as illustrated by reference numeral 304. Each dimension of the vector can include a weight relationship 302 to an associated logical block of the array. Recall, target block 306 can be a logical block with a weight relationship 302 that exceeds defined threshold 214. In this example, three logical blocks of the array have been identified as target blocks, and those blocks are shaded in FIG. 3 for convenience. Therefore, target blocks 306 have been determined to be sufficiently related to LB 1, the logical block referenced by IO transaction 104. Because of this relationship, target blocks 306 can be inferred to be likely to be referenced by a subsequent IO transaction. Thus, in response, cache 110 can be updated in an appropriate manner, which can result in improved response times. In some embodiments, the subsequent IO transaction can be one that occurs subsequently, but in a same time window as IO transaction 104. Additional detail in connection with an example time window is provided with reference to FIG. 6.

In some embodiments, weight relationship 302 can represent a determined probability that a subsequent IO transaction received by frontend device 106 will reference the target block 306. Again, subsequent IO transaction can be one that is subsequent to, but potentially in the same time window as, IO transaction 104. Hence, as illustrated, by weight relationships 302, LB 4 has been determined to have a 44% chance of being referenced later, LB A+1 has a 75% chance, and LB B+1 has a 90% chance. As can be appreciated, in the case of a read transaction and/or read cache operating, fetching these target blocks 306 to cache 110 can significantly improve cache efficiency over other techniques.

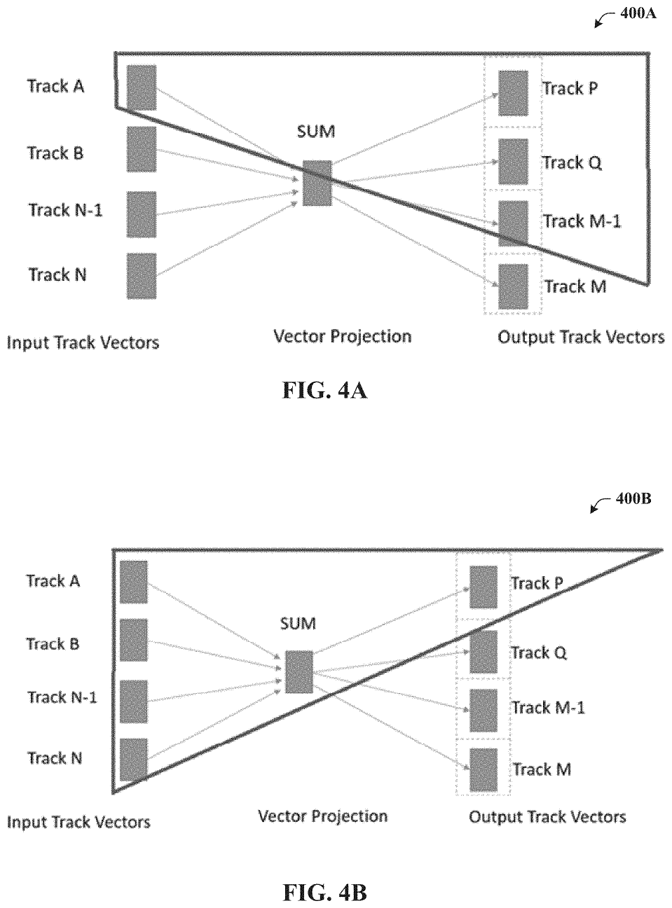

To this point in the disclosure, IO transaction 104 has been discussed in the context of a single IO transaction, however, it is appreciated that IO transaction 104 can represent many IO transactions 104, potentially from many different host devices 102. For example, IO data 202 can comprise information relating to multiple IO transactions 104, e.g., that occur during a particular time window. In that case, determination 208 can identify multiple input vectors 206, which can be combined and applied to weight matrix 216 to determine target blocks 306. FIGS. 4A and 4B graphically demonstrate these different embodiments.

Turning now to FIGS. 4A and 4B, illustrations 400A and 400B are provided. Illustration 400A depicts an example in which a single input vector is projected to identify target tracks in accordance with certain embodiments of this disclosure. Illustration 400B depicts an example in which a multiple input vectors are projected to identify one target track in accordance with certain embodiments of this disclosure. It is noted that in these examples, vectors are mapped to tracks (e.g., some multiple of a logical block), but it is appreciated that other aspects or techniques operate in a similar manner as detailed in connection with logical blocks.

With reference now to FIG. 5, block diagram 500 is depicted. Diagram 500 illustrates additional aspects or elements in connection with procedures to update cache 110 in accordance with certain embodiments of this disclosure. As has been discussed previously and illustrated here at reference numeral 502, update 218 to update cache 110 can be a function of cache type. In other words, a different set of instructions can be generated depending whether cache 110 is a read cache 110R or a write cache 110W. In that regard, read cache 110R can be employed to satisfy IO transactions 104 that are read transactions in a high-speed manner and/or without going to the backend after the fact to retrieve the data. Rather, as illustrated at reference numeral 504, that data can be prefetched beforehand, that is, prior to receiving the read request. Thus, there is no response time penalty, as the latency cost for fetching the data from the backend is paid in advance.

Hence, in some embodiments, update 218 can comprise, prior to receipt of the subsequent IO transaction, prefetching target data stored to target block(s) 306 of the array, and populating read cache 110R with the target data. Recall, target block(s) 306 are those that weight relationships 302 that are above threshold 214, and therefore determined to be highly likely to be referenced by subsequent IO transaction.

In some embodiments, update 218 can comprise removing, from read cache 110R, data of a non-target block of the array, wherein the non-target block is selected based on a determined non-target weight relationship between the non-target target block and the logical block being below a second defined threshold. In other words, data from blocks that have small weight relationship values can be purged from read cache 110, which can free space for data from blocks having higher weight relationship values. In some embodiments, data from blocks having a weight relationship 302 below threshold 214 can be removed. In some embodiments, data from blocks having a weight relationship 302 below a separately defined threshold can be removed. For example, suppose threshold 214 is set at 0.40 and the second threshold is set at 0.10. In that case, data from logical blocks for which there is a weight relationship 302 at or above 0.040 can be prefetched, while data in the cache from blocks for which there is a weight relationship 302 at or below 0.10 can be purged from read cache 110R.

Reference numeral 506 illustrated potentially different instructions in the case of a write cache 110W and/or in connection with IO transactions 104 that are write transactions. For instance, in some embodiments, update 218 can comprise performing a de-staging procedure prior to receipt of the subsequent IO transaction. This de-staging procedure can comprise one or more of the following:

For example, the de-staging procedure can comprise storing non-target data to a non-target block of the array. The non-target block can be selected based on a determined non-target weight relationship between the non-target target block and the logical block being below a second defined threshold.

The de-staging procedure can comprise removing the non-target data from write cache 110W. In other words, data from blocks having a low weight relationship 302 value can be immediately de-staged (e.g., saved to the backend). Once saved, that data can be removed from write cache 110W to free space for subsequent write transactions. It is again appreciated that the second threshold can be the same or different than threshold 214.

The de-staging procedure can further comprise maintaining the target data in write cache 110W. Hence, rather than de-staging all data from write cache 110W to free space for subsequent write transactions, some data, specifically data from blocks that have a high weight relationships 302 value, can remain in the cache. In other words, data from blocks that are likely to be referenced by a subsequent write transaction can remain in write cache 110W. It is appreciated that such can allow write transactions to more efficient because data that is likely to be overwritten by a subsequent IO transaction is not de-staged to the backend. Instead, the potential overwrite can be performed in cache 110W. The operation is distinct from treatment of read cache 110R, but the determinations can be based on the same or similar vectors, weight relationships, and techniques.

Referring now to FIG. 6, block diagram 600 is depicted. Diagram 600 illustrates additional aspects or elements in connection with neural network training in accordance with certain embodiments of this disclosure. For example, as depicted at reference numeral 602, a training procedure can be performed, e.g., by system 200. This training procedure can include various techniques or elements, examples of which are provided below.

For example, determination 604 relates to determining a time window having a fixed duration. A representative example of this time window can be one millisecond, but other values are contemplated (e.g., 0.5 milliseconds, 100 milliseconds, and so on). A one millisecond time window is representative because that duration is short enough to prevent or mitigate long-term dependency for the training procedure and help keep weight matrix 216 relatively small. A one millisecond time window is also comparable to a target response time for satisfying an IO transaction from cache 110. However, it is appreciated that the time window can be a configurable or adjustable value that can be updated or determined based on a variety of factors. In some embodiments the fixed duration of the time window is configurable based on at least one of: a target response time of the data facility, a target size range of weight matrix 216, and a current number of IO transactions per second (IOPS) of data facility 100 and so forth.

Once the time window has been selected or determined, the training procedure can continue with an incrementing or aggregation procedure illustrated at reference numeral 606. For example, the training procedure can comprise, incrementing an appropriate one of the respective weight relationships 302 in response to determining that the first block is referenced by a first IO transaction that occurs during the time window and one of the other blocks is referenced by a second IO transaction that occurs during the time window. In other words, when two different IO transactions occur during the time window, respective weight relationships between those two blocks can be incremented. Hence, of the course of the training procedures, the more frequently two blocks are referenced by IO transactions of the same time window, the greater the value of the weight relationships between those two blocks will become.

Once a sufficient number of time windows have been processed, vectors for each logical block or track can be generated, as depicted at reference numeral 608. This collection of vectors (e.g., one for each block or track) can be aggregated at reference numeral 610 to create weight matrix 216.

### Example Methods

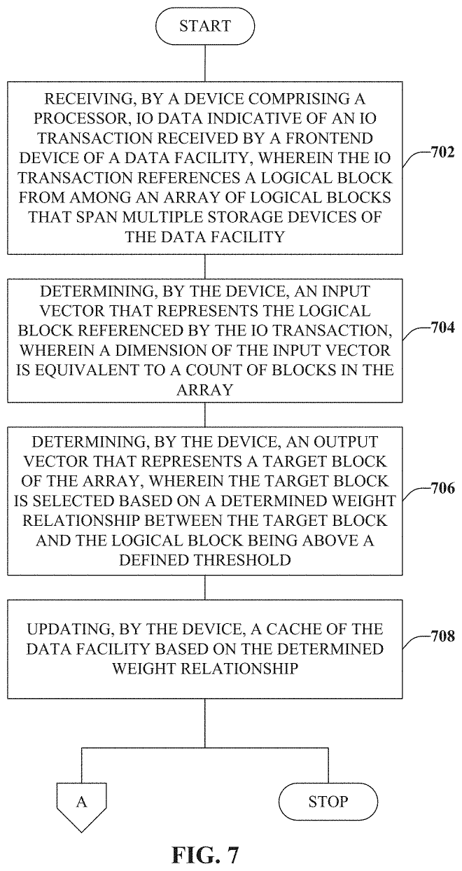

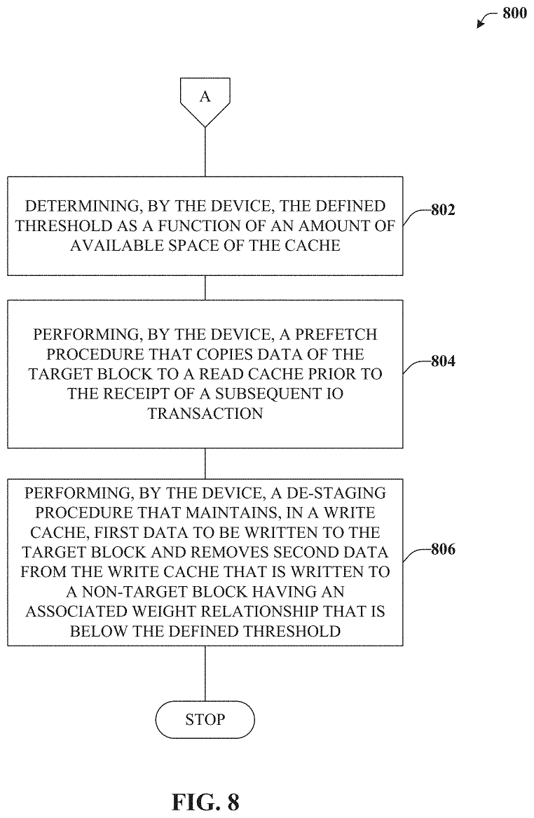

FIGS. 7 and 8 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers.

Referring now to FIG. 7, exemplary method 700 is depicted. Method 700 can intelligently manage a cache of a data facility to significantly improve cache efficiency in accordance with certain embodiments of this disclosure. While method 700 describes a complete methodology, in some embodiments, method 700 can include one or more elements of method 800, as illustrated by insert A.

At reference numeral 702, a device comprising a processor can receive IO data. This IO data can be indicative of an IO transaction received by a frontend device of a data facility. Typically, the IO transaction references a logical block from among an array of logical blocks that span multiple storage devices of the data facility. In such a scenario, it can be especially challenging to accurately predict data to prefetch or maintain in a cache in order to improve response times or other metrics.

At reference numeral 704, the device can determine an input vector that represents the logical block referenced by the IO transaction. A dimension of this input vector can be equivalent to a count of blocks in the array.

At reference numeral 706, the device can determine an output vector that represents a target block of the array. The target block can be selected based on a determined weight relationship between the target block and the logical block being above a defined threshold. In other words, target blocks can be those that have a sufficiently high (e.g., at or above the threshold) weight relationship.

At reference numeral 708, the device can update a cache of the data facility based on the determined weight relationship. For example, the cache can be updated such that blocks having a strong weight relationship with one or more of the logical blocks referenced by the IO transaction can be prioritized in some way in the cache. Such prioritizing can vary depending on a type of transaction or cache (e.g., whether the type relates to a read transaction/cache or a write transaction/cache). As depicted, method 700 can proceed to insert A, which is further detailed in connection with FIG. 8, or stop.

Turning now to FIG. 8, exemplary method 800 is depicted. Method 800 can provide for additional aspect or elements in connection with intelligently managing a cache of a data facility in accordance with certain embodiments of this disclosure.

At reference numeral 802, the device introduced at reference numeral 702 comprising a processor can determine the defined threshold as a function of an amount of available space of the cache. For example, if the cache at or near capacity, a high threshold can be selected. On the other hand, if the cache has substantial free space, a lower threshold can be selected.

At reference numeral 804, the device can perform a prefetch procedure that copies data of the target block to the read cache prior to the receipt of a subsequent IO transaction. In some embodiments, the prefetch procedure can include removing data from the cache that is deemed unlikely to be referenced by a subsequent IO transaction. While data selected for prefetching can be identified based on high weight relationships (e.g., values above a defined threshold), data selected for removal can be identified based on low weight relationships (e.g., values below the defined threshold or another threshold).

At reference numeral 806, the device can perform a de-staging procedure that maintains, in the write cache, first data to be written to the target block and removes second data from the write cache that is written to a non-target block having an associated weight relationship that is below the defined threshold. In other words, data associated with blocks having high weight relationships (e.g., values above a defined threshold) can be maintained in the write cache, whereas data associated with blocks having low weight relationships (e.g., values below the defined threshold or another threshold) can be de-staged.

### Example Operating Environments

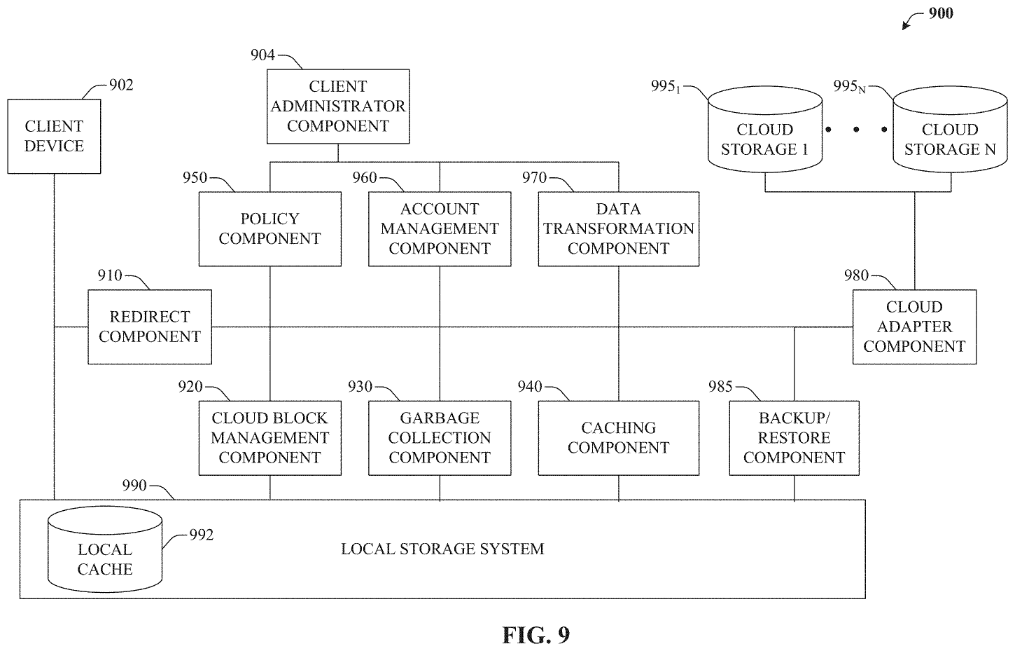

To provide further context for various aspects of the subject specification, FIGS. 9 and 10 illustrate, respectively, a block diagram of an example distributed file storage system 900 that employs tiered cloud storage and block diagram of a computer 1002 operable to execute the disclosed storage architecture in accordance with aspects described herein.

Referring now to FIG. 9, there is illustrated an example local storage system including cloud tiering components and a cloud storage location in accordance with implementations of this disclosure. Client device 902 can access local storage system 990. Local storage system 990 can be a node and cluster storage system such as an EMC Isilon Cluster that operates under OneFS operating system. Local storage system 990 can also store the local cache 992 for access by other components. It can be appreciated that the systems and methods described herein can run in tandem with other local storage systems as well.

As more fully described below with respect to redirect component 910, redirect component 910 can intercept operations directed to stub files. Cloud block management component 920, garbage collection component 930, and caching component 940 may also be in communication with local storage system 990 directly as depicted in FIG. 9 or through redirect component 910. A client administrator component 904 may use an interface to access the policy component 950 and the account management component 960 for operations as more fully described below with respect to these components. Data transformation component 970 can operate to provide encryption and compression to files tiered to cloud storage. Cloud adapter component 980 can be in communication with cloud storage 1 and cloud storage N, where N is a positive integer. It can be appreciated that multiple cloud storage locations can be used for storage including multiple accounts within a single cloud storage location as more fully described in implementations of this disclosure. Further, a backup/restore component 997 can be utilized to back up the files stored within the local storage system 990.

Cloud block management component 920 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 920 in chunks of data. A uniform chunk size can be selected where all files that tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 960 manages the information for cloud storage accounts. Account information can be populated manually via a user interface provided to a user or administer of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 920 based on list of mappings it manages. For example, each stub can be associated with an account, and the cloud block management component 920 can aggregate information from a set of stubs associated with the same account. Other example statistics that can be maintained include the number of recalls, the number of writes, the number of modifications, the largest recall by read and write operations, etc. In one implementation, multiple accounts can exist for a single cloud service provider, each with unique account names and access codes.

The cloud adapter component 980 manages the sending and receiving of data to and from the cloud service providers. The cloud adapter component 980 can utilize a set of APIs. For example, each cloud service provider may have provider specific API to interact with the provider.

A policy component 950 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 930. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 930 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 940 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 920, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 940 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 940 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that it has been placed in a queue, and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time it is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tacking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 970 can encrypt and/or compress data that is tiered to cloud storage. In relation to encryption, it can be appreciated that when data is stored in off-premises cloud storage and/or public cloud storage, users can require data encryption to ensure data is not disclosed to an illegitimate third party. In one implementation, data can be encrypted locally before storing/writing the data to cloud storage.

In one implementation, the backup/restore component 997 can transfer a copy of the files within the local storage system 990 to another cluster (e.g., target cluster). Further, the backup/restore component 997 can manage synchronization between the local storage system 990 and the other cluster, such that, the other cluster is timely updated with new and/or modified content within the local storage system 990.

Referring now to FIG. 10, there is illustrated a block diagram of a computer 1002 operable to execute the disclosed communication architecture. To provide additional context for various aspects of the disclosed subject matter, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices. The illustrated aspects of the specification can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, radio frequency (RF), infrared and other wireless media.

With reference again to FIG. 10, the example environment 1000 for implementing various aspects of the specification includes a computer 1002, the computer 1002 including a processing unit 1004, a system memory 1006 and a system bus 1008. As an example, the component(s), server(s), node(s), cluster(s), system(s), and/or device(s) disclosed herein can each include at least a portion of the computer 1002. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random-access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014, which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject disclosure.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to a HDD, a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods of the specification.

Many program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and/or a pointing device, such as a mouse 1040 or a touch screen or touchpad (not illustrated). These and other input devices are often connected to the processing unit 1004 through an input device interface 1042 that is coupled to the system bus 1008, but can be connected by other interfaces, such as a parallel port, an IEEE 1394 serial port, a game port, a USB port, an infrared (IR) interface, etc. A monitor 1044 or other type of display device is also connected to the system bus 1008 via an interface, such as a video adapter 1046.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., desktop and/or portable computer, server, communications satellite, etc. This includes at least Wi-Fi and Bluetooth® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 1002.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
receiving IO data indicative of an IO transaction received by a frontend device of a data facility, wherein the IO transaction references a logical block from among an array of logical blocks that span multiple storage devices of the data facility;
determining an input vector that represents the logical block referenced by the IO transaction, wherein a dimension of the input vector is equivalent to a count of blocks in the array;
determining an output vector that represents a target block of the array, wherein the target block is selected based on a determined weight relationship between the target block and the logical block being above a defined threshold; and
updating a cache of the data facility based on the determined weight relationship.

2. The system of claim 1, wherein the determined weight relationship represents a determined probability that a subsequent IO transaction received by the frontend device will reference the target block.

3. The system of claim 2, wherein the operations further comprise determining the defined threshold as a function of an amount of available space of the cache.

4. The system of claim 2, wherein the updating the cache comprises updating the cache further as a function of a type of the cache, wherein the type identifies one of: a read cache that stores first data read from the array, or a write cache that stores second data to be written to the array.

5. The system of claim 4, wherein the defined threshold is a first defined threshold, and wherein the updating the read cache comprises one of:
prior to receipt of the subsequent IO transaction, prefetching target data stored to the target block of the array, and populating the read cache with the target data; or
removing, from the read cache, data of a non-target block of the array, wherein the non-target block is selected based on a determined non-target weight relationship between the non-target target block and the logical block being below a second defined threshold.

6. The system of claim 4, wherein the defined threshold is a first defined threshold, and wherein the updating the write cache comprises performing a de-staging procedure prior to receipt of the subsequent IO transaction, the de-staging procedure comprising:
storing non-target data to a non-target block of the array, wherein the non-target block is selected based on a determined non-target weight relationship between the non-target target block and the logical block being below a second defined threshold;
removing the non-target data from the write cache; and
maintaining the target data in the write cache.

7. The system of claim 1, wherein the determining the output vector comprises applying the input vector to a weight matrix that comprises a number of vectors equivalent to the count of blocks in the array, and wherein a vector of the vectors represents a block of the array and indicates respective weight relationships between the block and other blocks of the array.

8. The system of claim 7, wherein the operations further comprise performing a training procedure that determines the respective weight relationships and generates the weight matrix representing a combination of the vectors.

9. The system of claim 8, wherein the training procedure comprises:
determining a time window having a fixed duration; and
incrementing an appropriate one of the respective weight relationships in response to determining that the first block is referenced by a first IO transaction that occurs during the time window and one of the other blocks is referenced by a second IO transaction that occurs during the time window.

10. The system of claim 9, wherein the fixed duration is one millisecond.

11. The system of claim 9, wherein the fixed duration is configurable according to at least one of: a target response time of the data facility, a target size range of the weight matrix, or a current IO transactions per second load of the data facility.

12. A computer-readable storage medium comprising instructions that, in response to execution, cause a device comprising a processor to perform operations, comprising:
receiving IO data indicative of an IO transaction received by a frontend device of a data facility, wherein the IO transaction references a logical block from among an array of logical blocks of multiple storage devices of the data facility;
selecting an input vector that represents the logical block referenced by the IO transaction, wherein a dimension of the input vector is equivalent to a count of blocks in the array;
determining an output vector that represents a target block of the array, wherein the target block is selected based on a determined weight relationship between the target block and the logical block being above a defined threshold; and
updating a cache of the data facility based on the determined weight relationship.

13. The computer-readable storage medium of claim 12, wherein the determined weight relationship represents a determined probability that a subsequent IO transaction received by the frontend device will reference the target block.

14. The computer-readable storage medium of claim 12, wherein the updating the cache comprises updating the cache further as a function of a type of the cache, wherein the type designates one from a group of caches comprising: a read cache that stores first data read from the array, and a write cache that stores second data to be written to the array.

15. The computer-readable storage medium of claim 14, wherein the defined threshold is a first defined threshold, and wherein the updating the read cache comprises one of:
prior to receipt of the subsequent IO transaction, prefetching target data stored to the target block of the array, and populating the read cache with the target data; or
removing, from the read cache, data of a non-target block of the array, wherein the non-target block is selected based on a determined non-target weight relationship between the non-target target block and the logical block being below a second defined threshold.

16. The computer-readable storage medium of claim 14, wherein the defined threshold is a first defined threshold, and wherein the updating the write cache comprises performing a de-staging procedure prior to receipt of the subsequent IO transaction, the de-staging procedure comprising:
storing non-target data to a non-target block of the array, wherein the non-target block is selected based on a determined non-target weight relationship between the non-target target block and the logical block being below a second defined threshold;
removing the non-target data from the write cache; and
maintaining the target data in the write cache.

17. A method, comprising:
receiving, by a device comprising a processor, IO data indicative of an IO transaction received by a frontend device of a data facility, wherein the IO transaction references a logical block from among an array of logical blocks that span multiple storage devices of the data facility;
determining, by the device, an input vector that represents the logical block referenced by the IO transaction, wherein a dimension of the input vector is equivalent to a count of blocks in the array;
determining, by the device, an output vector that represents a target block of the array, wherein the target block is selected based on a determined weight relationship between the target block and the logical block being above a defined threshold; and
updating, by the device, a cache of the data facility based on the determined weight relationship.

18. The method of claim 17, further comprising determining, by the device, the defined threshold as a function of an amount of available space of the cache.

19. The method of claim 18, wherein the cache is a read cache, and further comprising performing, by the device, a prefetch procedure that copies data of the target block to the read cache prior to the receipt of a subsequent IO transaction.

20. The method of claim 18, wherein the cache is a write cache, and further comprising performing, by the device, a de-staging procedure that maintains, in the write cache, first data to be written to the target block and removes second data from the write cache that is written to a non-target block having an associated weight relationship that is below the defined threshold.
